(19) United States
(12) Patent Application Publication
(10) Pub. No.: US 2020/0124052 A1
(43) Pub. Date: Apr. 23, 2020

(54) FAN ASSEMBLY WITH RECIRCULATION FLOW

(71) Applicant: PRATT & WHITNEY CANADA CORP., Longueuil (CA)

(72) Inventors: Hien DUONG, Mississauga (CA); Vijay KANDASAMY, T. Palur (IN)

(21) Appl. No.: 16/165,561

(22) Filed: Oct. 19, 2018

(51) Int. Cl. F04D 27/02; F04D 29/52; F04D 29/54

(52) U.S. Cl. CPC F04D 27/0238; F02K 3/06; F04D 29/547; F04D 29/522

(57) ABSTRACT

A fan assembly for a gas turbine engine includes a fan rotor having a hub and fan blades protruding from the hub. A fan stator is located downstream of the fan rotor and has vanes extending between radially inner ends and radially outer ends. A flow recirculation circuit has an inlet located downstream of the vanes of the fan stator and adjacent the radially inner ends thereof. The flow recirculation circuit has an outlet located upstream of the inlet. The outlet is located at the hub of the fan rotor and upstream of trailing edges of the fan blades.

### TECHNICAL FIELD

The application relates generally to gas turbine engines and, more particularly, to fan assemblies of turbofan gas turbine engines.

### BACKGROUND

The fans of many turbofan gas turbine engines have fan blades that have a high slope at their radially inner ends and have a large change in radius from leading edges to trailing edges of the fan blades. These geometric parameters may provide certain aerodynamic advantages. However, when the chord lengths of the fan blades are minimized for reducing overall weight, or when the thicknesses of the fan blades are increased for structural reasons, the resulting high slope may compromise the flow downstream of the fan blades. Consequently, the flow downstream of the fan blades can sometimes carry large circumferential wake and thick end wall boundary layers. This may impair performance of downstream components of the gas turbine engine.

### SUMMARY

There is accordingly provided a fan assembly for a gas turbine engine comprising: a fan rotor rotatable about an axis, the fan rotor including a hub and fan blades protruding from the hub, the fan blades having a leading edge and a trailing edge; a fan stator downstream of the fan rotor relative to a direction of an airflow through the fan assembly, the fan stator including vanes extending between radially inner ends and radially outer ends; and a flow recirculation circuit having an inlet located downstream of the vanes of the fan stator and adjacent the radially inner ends thereof, the flow recirculation circuit having an outlet located upstream of the inlet relative to the direction of the airflow through the fan assembly, the outlet located at the hub of the fan rotor and upstream of the trailing edges of the fan blades.

There is also provided a turbofan gas turbine engine comprising; a fan rotor rotatable about an axis, the fan rotor including a hub and fan blades protruding from the hub, the fan blades having a leading edge and a trailing edge; a fan stator downstream of the fan rotor relative to a direction of an airflow through the fan, the fan stator including vanes extending between radially inner ends and radially outer ends; a compressor rotor downstream of the fan stator and rotatable about the axis; and a flow recirculation circuit having an inlet located downstream of the vanes of the fan stator and upstream of the compressor rotor, the inlet of the flow recirculation circuit adjacent the radially inner ends of the vanes, the flow recirculation circuit having an outlet located upstream of the inlet relative to the direction of the airflow through the fan, the outlet of the flow recirculation circuit located at the hub of the fan rotor and upstream of the trailing edges of the fan blades.

There is further provided a method of operating a fan assembly of a gas turbine engine comprising: receiving an airflow between fan blades extending from a hub of a fan rotor of the fan assembly rotatable about an axis and between vanes of a fan stator, the fan stator located downstream of the fan rotor relative to the airflow; drawing a portion of the airflow from downstream of the fan stator proximate radially inner ends of the vanes; and injecting the drawn portion of the airflow upstream of trailing edges of the fan blades of the fan rotor and adjacent the hub.

In the method as described above, injecting the drawn portion may also include injecting the drawn portion in a direction corresponding to that of the airflow circulating between the fan blades.

In the method as described above, wherein injecting the drawn portion may also include increasing a velocity of the drawn portion.

### BRIEF DESCRIPTION OF THE DRAWINGS

Reference is now made to the accompanying figures in which:

FIG. 1 is a schematic cross-sectional view of a gas turbine engine; and

FIG. 2 is a schematic cross-sectional detailed view of a portion of the gas turbine engine of FIG. 1 showing the fan assembly as described herein.

### DETAILED DESCRIPTION

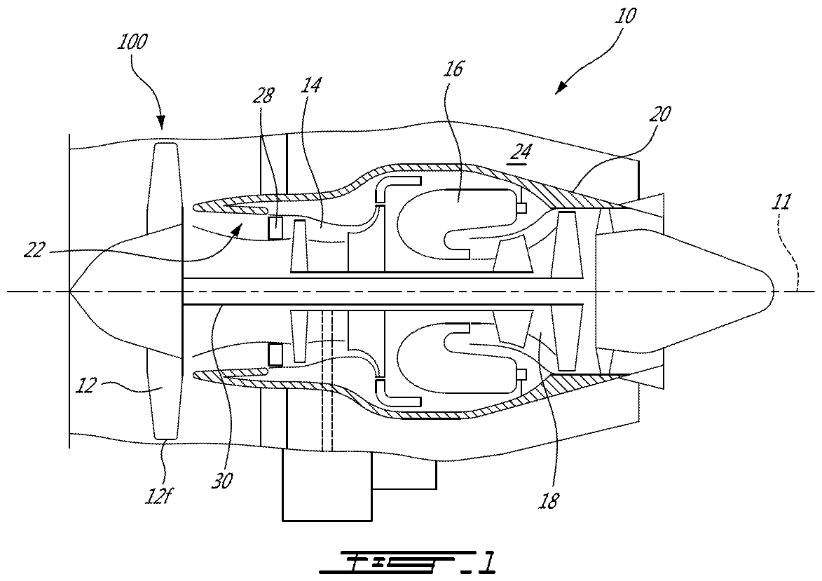

FIG. 1 illustrates a gas turbine engine 10 of a type preferably provided for use in subsonic flight, generally comprising in serial flow communication a fan assembly 100, which includes a fan rotor 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The fan rotor, the compressor section 14, and the turbine section 18 are rotatable about the axis 11.

The gas turbine engine 10 has an engine casing 20 that circumferentially extends around the axis 11. The gas turbine engine 10 defines a core flow path 22 located radially inwardly of the engine casing 20 relative to the axis 11 and a bypass flow path 24 located radially outwardly of the engine casing 20 relative to the axis 11.

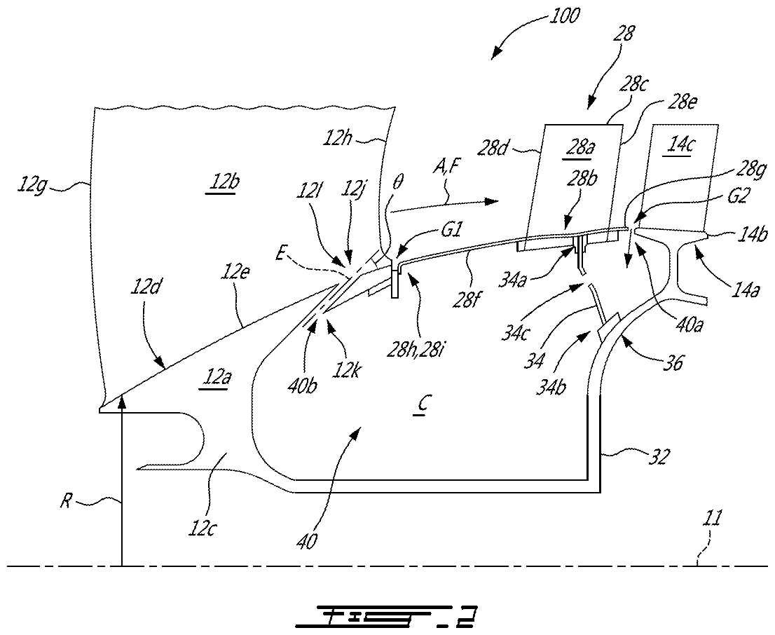

Referring to FIGS. 1-2, the fan assembly 100 includes the fan rotor 12, and a fan core stator (or simply “fan stator”) 28 which is located within the engine core downstream of the fan rotor 12, relative to a direction of an airflow F circulating in the gas turbine engine 10. The direction of the airflow F is denoted by arrow A. The fan rotor 12 and the fan stator 28 are described one by one herein after.

The fan rotor 12 includes a hub 12a and fan blades 12b protruding radially outwardly from the hub 12a relative to the axis 11. The hub 12a is securable to a shaft 30 (FIG. 1) of the gas turbine engine 10 for integral rotation therewith. In the depicted embodiment, the hub 12a includes a disk 12c; the disk 12c defining a platform 12d from which the fan blades 12b protrude. The disk 12c may be secured to the shaft 30 of the gas turbine engine 10 for integral rotation therewith.

The fan blades 12b have radially inner ends 12e secured to the hub 12a and radially outer ends 12f (FIG. 1) that may be unsupported, or free. The fan blades 12b have leading edges 12g and trailing edges 12h downstream of the leading edges 12g relative to the direction of the airflow F, and pressure and suction sides extending from the leading edges 12g to the trailing edges 12h and from the radially inner ends 12e to the radially outer ends 12f on both sides of the fan blades 12b. The fan blades 12b extend through both of the core flow path 22 and the bypass flow path 24.

The platform 12d defines a wall that circumferentially extends all around the axis 11 to prevent the airflow F from flowing radially inwardly to the radially inner ends 12e of the fan blades 12b toward the axis 11. Stated otherwise, the wall defined by the platform 12d limits the airflow F from leaving the core flow path 22.

The fan stator 28 includes vanes 28a that extend between radially inner ends 28b and radially outer ends 28c. In the depicted embodiment, the vanes 28a are secured to the engine casing 20 (FIG. 1) at their radially outer ends 28c. Other configurations are contemplated without departing from the scope of the present disclosure. The vanes 28 have leading edges 28d and trailing edges 28e downstream of the leading edges 28d relative to the direction of the airflow F, and pressure and suction sides extending from the leading edges 28d to the trailing edges 28e and from the radially inner ends 28b to the radially outer ends 28c and on both sides of the vanes 28a. In the embodiment shown, the vanes 28a extend solely through the core flow path 22.

In the depicted embodiment, the vanes 28a protrude radially outwardly from a stationary stator platform 28f. The stator platform 28f has a downstream end 28g located adjacent the trailing edges 28e of the vanes 28a and an upstream 28h end that is axially spaced apart from the leading edges 28d of the vanes 28d relative to the axis 11. The stator platform 28f of the fan stator 28 defines a lip 28i at its upstream end 28h; the lip 28i being axially spaced apart from the hub 12a of the fan rotor 12 by a first gap G1. The first gap G1 is maintained as small as possible to limit air from leaking out of the core flow path 22. The first gap G1 is present to allow the hub 12a of the fan rotor 12 and the platform 28f of the fan stator 28 to rotate one relative to the other. A sealing engagement may be provided at the first gap G1 for preventing the airflow F from leaking out of the core flow path 22. This is similar to the arrangement at 34b.

As shown in FIG. 2, the fan stator 28 is located upstream of a core compressor rotor 14a of the compressor section 14 relative to the direction of the airflow F. The compressor rotor 14a rotates integrally with the shaft 30 of the gas turbine engine 10 and rotates integrally with the fan rotor 12. As illustrated, the compressor rotor 14a is secured to the hub 12a of the fan rotor 12 via a rotating wall 32; the rotating wall 32 may be secured to the shaft 30. It is understood that although the hub 12a of the fan rotor 12, the rotating wall 32, and the compressor rotor 14a have been shown as being monolithic, other configurations are contemplated without departing from the scope of the present disclosure. In the embodiment shown, a second gap G2 is defined between the platform 28f of the fan stator 28 and the compressor rotor 14a. More specifically, the second gap G2 is located between the platform 28f of the fan stator 28 and a platform 14b of the compressor rotor 14a from which compressor blades 14c protrude. The second gap G2 allows the compressor rotor 14a and the fan stator 28 to rotate one relative to the other.

In the embodiment shown, an annular cavity C is defined axially between the fan rotor 12 and the compressor rotor 14a and radially between the rotating wall 32 and the platforms 12d, 28f of the fan rotor 12 and of the fan stator 28. The annular cavity C extends circumferentially all around the axis 11.

As illustrated, to prevent air circulating in the core flow path 22 from leaking in the annular cavity C, a stationary wall 34 extends radially between the radially inners ends 28b of the vanes 28a and the rotating wall 32. More specifically, and as illustrated in FIG. 2, a radially outer end 34a of the stationary wall 34 is secured to the vanes 28a and a sealing engagement 36 is provided between the rotating wall 32 and a radially inner end 34b of the stationary wall 34. The sealing engagement 36 may be provided by any suitable seal, such as, a labyrinth seal.

As illustrated, a radius R of the platform 12d of the hub 12a increases rapidly from the leading edges 12g to the trailing edges 12h of the fan blades 12b. It has been observed that such a large change in radius may have many benefits, such as, keeping the fan W/A low (where W is mass flow and A is area), reducing the fan ΔH/U² (where ΔH is rotor work and U is rotational speed of the rotor), increasing the wheel speed of the low pressure (LP) compressor, and so on.

However, it has been observed that when chords of the fan blades 12b are minimized to reduce engine weight and/or length, and/or when thicknesses of the fan blades 12b are increased near their radially inner ends 12e for structural reason, the high rate of change of the radius R of the platform 12d of the hub 12a, and/or insufficient length of the platforms 28f, might compromise the airflow F in the vicinity of the hub 12a.

Indeed, at a rotational speed corresponding to about 80-90% of a design rotational speed of the fan rotor 12, the airflow F may carry large circumferential wake and thick end wall boundary layer. That might lead to an additional 10 degrees of positive incidence at the leading edges 28d of the vanes 28a of the fan stator 28. This end wall boundary layer might initiate premature stall on the fan stator 28 due to lower momentum, increase incidence of the vanes 28a of the fan stator 28, and increase in secondary flow. The above discussed effects might be compounded as the airflow F travels downstream and might negatively impair performance of downstream components (e.g., compressor section 14) of the gas turbine engine 10.

In the depicted embodiment, a flow recirculation circuit 40 is provided. The flow recirculation circuit as used herein is understood to be an airflow path, which may be composed of one or more interconnected passages, plenums, cavities, pipes, and/or conduits, and the like, or any combination of these as may be suitable to establish the airflow path for the recirculation air. The “circuit” 40 for flow recirculation may be an open circuit or a closed circuit. A flow path between parts, for example, may form all or part of the flow recirculation circuit 40, as can a fully enclosed air conduit. As illustrated, the flow recirculation circuit 40 encompasses the annular cavity C. The flow recirculation circuit 40 has an inlet 40a located downstream of the vanes 28a of the fan stator 28 and adjacent the radially inner ends 28b of the vanes 28a and has an outlet 40b located upstream of the inlet 40a relative to the direction of the airflow F. The outlet 40b of the flow recirculation circuit 40 is located at the hub 12a of the fan rotor 12 and upstream of the trailing edges 12h of the fan blades 12b. In the embodiment shown, the outlet 40b of the flow recirculation circuit is located downstream of the leading edges 12g of the fan blades 12b. In a particular embodiment, the outlet 40b of the flow recirculation circuit 40 is located between 75% and 85% of a chord length of the fan blades 12b at their radially inner ends 12e from the leading edges 12g of the fan blades 12, in order to best energize the rotor endwall boundary layer. In one particular embodiment, the outlet 40b of the flow recirculation circuit 40 is located at about 80% of the chord length of the fan blades 12b.

As illustrated in FIG. 2, the inlet 40a of the flow recirculation circuit 40 corresponds to the second gap G2, which is located between the fan stator 28 and the compressor rotor 14a, more specifically between their respective platforms 28f, 14b. Therefore, the inlet 40a of the flow recirculation circuit 40 is located downstream of the vanes 28a of the fan stator 28 and upstream of the compressor rotor 14a.

In the embodiment shown, apertures 34c are provided through the stationary wall 34. The apertures 34c may be circumferentially distributed around the axis 11 and are suitably sized to allow the required mass flow rate to pass from one side of the stationary wall 34 to the other.

In the depicted embodiment, the outlet 40b of the flow recirculation circuit 40 is provided in the form of apertures 12j defined through the hub 12a, more specifically through the platform 12d. In the embodiment shown, each of the apertures 12j is located between two adjacent ones of the fan blades 12b. The apertures 12j may be holes or slots and may be sized according to the desired mass flow rate to pass therethrough.

As illustrated in FIG. 2, each of the apertures 12j defined through the hub 12a has an exit flow axis E that defines an acute angle theta with the hub 12a downstream of the apertures 12j. The exit flow axis E is oriented such that the air circulating therein re-enters the core flow path 22 parallel to the direction of the airflow F circulating in the core flow path 22 near the hub 12a. Such an embodiment may reduce mixing losses.

In a particular embodiment, the air circulating in the flow recirculation circuit 40 is accelerated prior to re-entering in the core flow path 22. In a particular embodiment, the acceleration of the air may be carried by the apertures 12j defined through the platform 12d of the hub 12a; the apertures 12j having a cross-sectional area greater at their inlets 12k than that at their outlets 121.

For operating the fan assembly 100 the airflow F is received between the fan blades 12b extending from the hub 12a of the fan rotor 12. A portion of the airflow is drawn from downstream of the fan stator 28 and from the radially inner ends 28b of the vanes 28a. The drawn portion of the airflow is injected upstream of the trailing edges 12h of the fan blades 12b of the fan rotor 12 and adjacent the hub 12a.

In the depicted embodiment, drawing the portion of the airflow F includes drawing the portion of the airflow via the second gap between the fan stator 28 and the compressor rotor 14a. As illustrated, injecting the drawn portion of the airflow F includes injecting the drawn portion of the airflow through the apertures 12j defined through the hub 12a.

In the embodiment shown, injecting the drawn portion of the airflow F through the apertures 12j includes injecting the drawn portions through the apertures 12j that are located between 75% and 85% of the chord length of the fan blades 12b from leading edges 12g of the fan blades 12b (and more particularly are located at about 80% of the chord length). As illustrated in FIG. 2, injecting the drawn portion of the airflow F includes injecting the drawn portion in a direction corresponding to that of the airflow F circulating between the fan blades 12b. The velocity of the drawn portion of the airflow may be increased when injected upstream of the trailing edges 12h of the fan blades 12b.

In a particular embodiment, the air that is re-injected near the radially inner ends of the fan blades re-energizes the airflow in the core flow path. This might yield a thinner boundary layer compared to the same configuration without the flow recirculation circuit. In a particular embodiment, about from 1% to 3% of the flow circulating in the core flow path is directed in the flow recirculation circuit. In a particular embodiment, recirculating the flow enhances the flow conditions of the fan stator and improves its stall range. This might allow the fan stator to retain its optimum shape at design conditions for best performance. In a particular embodiment, improving the fan exit flow conditions through flow recirculation as described herein benefits components downstream of the fan assembly.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A fan assembly for a gas turbine engine comprising: a fan rotor rotatable about an axis, the fan rotor including a hub and fan blades protruding from the hub, the fan blades having a leading edge and a trailing edge; a fan stator downstream of the fan rotor relative to a direction of an airflow through the fan assembly, the fan stator including vanes extending between radially inner ends and radially outer ends; and a flow recirculation circuit having an inlet located downstream of the vanes of the fan stator and adjacent the radially inner ends thereof, the flow recirculation circuit having an outlet located upstream of the inlet relative to the direction of the airflow through the fan assembly, the outlet located at the hub of the fan rotor and upstream of the trailing edges of the fan blades.

2. The fan assembly of claim 1, wherein the outlet includes apertures defined through the hub of the rotor.

3. The fan assembly of claim 2, wherein cross-sectional areas of the apertures in the hub of the rotor decrease from their inlets to their outlets.

4. The fan assembly of claim 2, wherein the apertures in the hub of the rotor have an exit flow axis defining an acute angle with the hub downstream of the apertures.

5. The fan assembly of claim 1, wherein the outlet of the flow recirculation circuit is located downstream of the leading edges of the blades relative to the flow.

6. The fan assembly of claim 1, wherein the outlet of the flow recirculation circuit is located at a point disposed between 75% and 85% of a chord length of the fan blades from the leading edges.

7. The fan assembly of claim 6, wherein the outlet of the flow recirculation circuit is located at about 80% of the chord length of the fan blades from the leading edges.

8. The fan assembly of claim 1, wherein the inlet of the flow recirculation circuit is an annular gap circumferentially extending all around the axis, the annular gap located between platforms of the vanes from which the vanes extend radially outwardly and platforms of a compressor rotor of a compressor of the gas turbine engine, the compressor rotor downstream of the vanes relative to the direction of the airflow.

9. A turbofan gas turbine engine comprising; a fan rotor rotatable about an axis, the fan rotor including a hub and fan blades protruding from the hub, the fan blades having a leading edge and a trailing edge; a fan stator downstream of the fan rotor relative to a direction of an airflow through the fan, the fan stator including vanes extending between radially inner ends and radially outer ends; a compressor rotor downstream of the fan stator and rotatable about the axis; and a flow recirculation circuit having an inlet located downstream of the vanes of the fan stator and upstream of the compressor rotor, the inlet of the flow recirculation circuit adjacent the radially inner ends of the vanes, the flow recirculation circuit having an outlet located upstream of the inlet relative to the direction of the airflow through the fan, the outlet of the flow recirculation circuit located at the hub of the fan rotor and upstream of the trailing edges of the fan blades.

10. The turbofan gas turbine engine of claim 9, wherein the outlet includes apertures defined through the hub of the rotor.

11. The turbofan gas turbine engine of claim 10, wherein cross-sectional areas of the apertures decrease from their inlets to their outlets.

12. The turbofan gas turbine engine of claim 10, wherein the apertures have an exit flow axis defining an acute angle with the hub downstream of the apertures.

13. The turbofan gas turbine engine of claim 9, wherein the outlet of the flow recirculation circuit is located downstream of the leading edges of the blades relative to the flow.

14. The turbofan gas turbine engine of claim 9, wherein the outlet of the flow recirculation circuit is located between 75% and 85% of a chord length of the fan blades from the leading edges.

15. The turbofan gas turbine engine of claim 14, wherein the outlet of the flow recirculation circuit is located at about 80% of the chord length of the fan blades from the leading edges.

16. The turbofan gas turbine engine of claim 9, wherein the inlet of the flow recirculation circuit is an annular gap circumferentially extending all around the axis, the annular gap located between platforms of the vanes from which the vanes extend radially outwardly and platforms of the compressor rotor.

17. A method of operating a fan assembly of a gas turbine engine comprising:
receiving an airflow between fan blades extending from a hub of a fan rotor of the fan assembly rotatable about an axis and between vanes of a fan stator, the fan stator located downstream of the fan rotor relative to the airflow;
drawing a portion of the airflow from downstream of the fan stator proximate radially inner ends of the vanes; and
injecting the drawn portion of the airflow upstream of trailing edges of the fan blades of the fan rotor and adjacent the hub.

18. The method of claim 17, wherein drawing the portion of the airflow includes drawing the portion of the airflow via a gap between the fan stator and a rotor of a compressor of the gas turbine engine.

19. The method of claim 17, wherein injecting the drawn portion of the airflow includes injecting the drawn portion of the airflow through apertures defined through the hub.

20. The method of claim 19, wherein injecting the drawn portion through the apertures includes injecting the drawn portions through the apertures located at at least 80% of a chord length of the fan blades from leading edges of the fan blades.
